(19) United States
(12) Patent Application Publication
(10) Pub. No.: US 2006/0221484 A1
(43) Pub. Date: Oct. 5, 2006

(54) Magnetic disk apparatus

(75) Inventor: Tomomi Funayama, Tokorozawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/384,266

(22) Filed: Mar. 21, 2006

(30) Foreign Application Priority Data
Mar. 30, 2005 (JP) 2005-097720

(51) Int. Cl. G11B 5/03

(52) U.S. Cl. 360/66

(57) ABSTRACT

A magnetic disk apparatus with a magnetic disk medium capable of recording data magnetically, comprises a current perpendicular to plane magnetic reproducing head which includes a magnetoresistive effect element composed of a plurality of magnetic films stacked one on top of another and causes sense current to flow in the direction perpendicular to the stacked faces of the plurality of magnetic films, a high-pass filter which suppresses the low-frequency component of a reproduced signal output from the magnetic reproducing head, and a reproduced-signal processing section which reproduces the data from the reproduced signal which has the low-frequency component suppressed.

### CROSS-REFERENCE TO RELATED APPLICATIONS

This application is based upon and claims the benefit of priority from Japanese Patent Application No. 2005-097720, filed Mar. 30, 2005, the entire contents of which are incorporated herein by reference.

### BACKGROUND

1. Field

One embodiment of the invention relates to a magnetic disk apparatus using a current perpendicular to plane (CPP) magnetic head.

2. Description of the Related Art

In recent years, the size of a magnetic recording apparatus, such as a hard disk unit, has been getting increasingly smaller and the recording density has been getting higher. This trend is expected to get stronger in future. As the recording density is getting higher, a higher-sensitivity sensor is required. To meet this requirement, a CPP-GMR (current perpendicular to plane—GMR) element has been developed. Using CPP-GMR elements makes it possible to form a high-density, high-output magnetic head.

In a magnetic head using this type of magnetoresistive effect element, sense current is caused to flow across the film thickness of the magnetic film. Therefore, as the head size reduces, the cross-sectional area of the film surface which bias current crosses decreases, resulting in an increase in the current density. Then, in a distinctive phenomenon, noise induced by the spin transfer effect becomes conspicuous.

The spin transfer effect is such that torque to change the direction of the magnetization of the element is produced by replacing electrons in a magnetic material with spin angular momentums when spin-polarized electrons flow in the magnetic material. This phenomenon becomes pronounced and noise in the reproduced signal becomes larger, making reading errors liable to occur. Therefore, suitable measures to deal with this problem are desired to be taken.

As related techniques, an example of measures against noise in the reproduced signal has been disclosed in Jpn. Pat. Appln. KOKAI Publication No. 6-259702. In this document, measures against noise resulting from the magnetic wall of the lining layer of a magnetic disk medium have been described. The magnetic head in the document is of a so-called single-magnetic-pole type which does recording and reproducing using the same element on the head. Moreover, in the document, there has been no description of CPP-GMR elements and it hasn't been expected that a sufficient reproduced output is obtained on the physical scale dealt with in the present invention.

As described above, in the current perpendicular to plane magnetic head, as the size of the head reduces, the effect of noise caused by the spin transfer effect becomes greater, making reading errors liable to occur. Accordingly, a rise in the recording density may reach a ceiling and therefore suitable measures against this are desired to be taken.

### SUMMARY

According to an aspect of the present invention, there is provided a magnetic disk apparatus with a magnetic disk medium capable of recording data magnetically, comprising a current perpendicular to plane magnetic reproducing head which includes a magnetoresistive effect element composed of a plurality of magnetic films stacked one on top of another and causes sense current to flow in the direction perpendicular to the stacked faces of said plurality of magnetic films; a high-pass filter which suppresses the low-frequency component of a reproduced signal output from the magnetic reproducing head; and a reproduced-signal processing section which reproduces the data from the reproduced signal which has the low-frequency component suppressed.

With such means, the low-frequency components of the reproduced signal are suppressed. Since the noise components caused by the spin transfer effect are biased toward the low-frequency side, the noise components can be removed effectively with the above configuration, which makes it possible to improve the recording density of the magnetic disk apparatus more.

According to the present invention, noise caused by the spin transfer effect can be reduced and the recording density of the magnetic disk apparatus can be improved more.

For purposes of summarizing the invention, certain aspects, advantages, and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary functional block diagram of a first embodiment of a magnetic disk apparatus according to the present invention;

FIG. 2 is an exemplary external perspective view of a hard disk unit in which a magnetic head related to the embodiment can be installed;

FIG. 3 is an exemplary sectional view showing a schematic configuration of the reproducing head 1 of FIG. 1;

FIG. 4 is an exemplary sectional view showing a film configuration of the magnetoresistive effect film 10 of FIG. 3;

FIG. 5 shows an exemplary graph obtained by measuring the spectrum of head noise at the reproducing head 1 with and without a high-pass filter 3;

FIG. 6 is an exemplary functional block diagram of a second embodiment of a magnetic disk apparatus according to the present invention;

FIG. 7 schematically shows an exemplary magnetoresistive effect film in a third embodiment of a magnetic disk apparatus according to the present invention;

FIG. 8 shows a graph obtained by measuring the spectrum of head noise at the reproducing head 1 having a magnetoresistive effect film 10 including a current control layer in the case of the presence and absence of a high-pass filter and differentiating circuit 7;

FIG. 9 is an exemplary functional block diagram of a fourth embodiment of a magnetic disk apparatus according to the present invention; and

FIG. 10 is an exemplary diagram to help explain the operation of the read bias adjusting circuit 8 of FIG. 9.

### DETAILED DESCRIPTION

Various embodiments according to the invention will be described hereinafter with reference to the accompanying drawings. In general, according to one embodiment of the invention, a magnetic disk apparatus with a magnetic disk medium capable of recording data magnetically, comprising a current perpendicular to plane magnetic reproducing head which includes a magnetoresistive effect element composed of a plurality of magnetic films stacked one on top of another and causes sense current to flow in the direction perpendicular to the stacked faces of said plurality of magnetic films; a high-pass filter which suppresses the low-frequency component of a reproduced signal output from the magnetic reproducing head; and a reproduced-signal processing section which reproduces the data from the reproduced signal which has the low-frequency component suppressed.

### First Embodiment

According to an embodiment, FIG. 1 is an exemplary functional block diagram of a first embodiment of a magnetic disk apparatus according to the present invention. In FIG. 1, a reproducing head 1, which is used in proximity to a magnetic disk medium (not shown), and outputs a reproduced signal whose waveform corresponds to the magnetic field at the surface of the medium. The reproduced signal is amplified by a read amplifier 2. Its low-frequency components are suppressed by a high-pass filter (HPF) 3. The low-frequency-suppressed reproduced signal is input to a reproduced-signal processing section 4, which reproduces the data on the disk medium. The reproduced-signal processing section 4 is connected to a hard disk controller (HDC) 5 and a CPU (Central Processing Unit) 6. The hard disk controller 5 and CPU 6 perform a reproduced data error correcting process and positioning control of the reproducing head 1.

The reproducing head of FIG. 1 includes a magnetoresistive effect element composed of a plurality of magnetic films stacked one on top of another. The resistance of the magnetoresistive effect element changes according to the radiation magnetic field from the surface of the disk medium. A reproduced signal is obtained by sensing the change. The reproducing head 1 of FIG. 1 is particularly of the current perpendicular to plane type. In this type of reproducing head, a sense current for sensing a change in the resistance flows in the direction perpendicular to the stacked faces of the magnetic films.

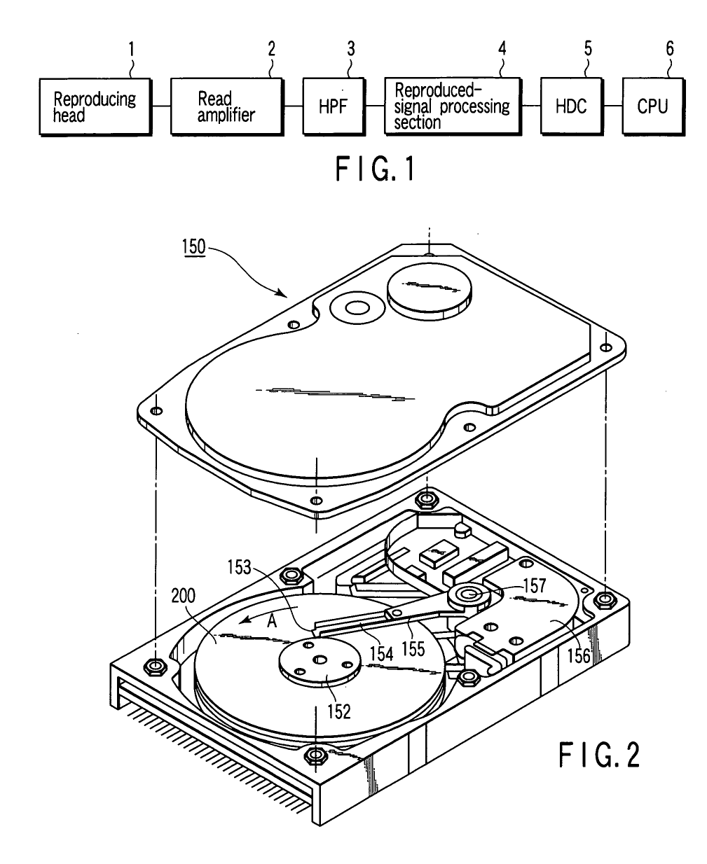

FIG. 2 is an exemplary external perspective view of a hard disk unit in which the magnetic head of the embodiment can be installed. The magnetic head related to the invention can be installed in a magnetic reproducing apparatus which reads the digital data magnetically recorded on a magnetic disk medium. A typical magnetic disk medium is a platter built in a hard disk drive. Moreover, the magnetic head of the invention can be installed in a magnetic recording/reproducing apparatus which also has the function of writing digital data onto a magnetic disk medium.

In the hard disk unit 150 of FIG. 2, a rotary actuator is used to move the magnetic head. In FIG. 2, a recording disk medium 200 is mounted on a spindle 152. The disk medium 200 is rotated in the direction shown by arrow A by a motor which responds to a control signal from a driving unit control section (not shown). More than one disk medium 200 may be provided. This type of apparatus is called a multi-platter type.

A head slider 153, which is provided at the tip of a thin-film suspension 154, stores information onto the disk medium 200 and reproduces the information recorded on the disk medium 200. The head slider 153 has the reproducing head 1 of FIG. 1 installed near its tip. The disk medium 200 rotates, causing the medium facing side (ABS) of the head slider 153 to float up a constant distance from the surface of the disk medium 200. The magnetic head of the invention may be applied to a so-called contact travel type which causes the slider to come into contact with the disk medium 200.

A suspension 154 is connected to one end of an actuator arm 155 which includes a bobbin section (not shown) holding a driving coil (not shown). To the other end of the actuator arm 155, a voice coil motor 156, a kind of linear motor, is provided. The voice coil motor 156 is composed of a driving coil (not shown) wound around the bobbin section of the actuator arm 155 and a magnetic circuit made up of a permanent magnet and a facing yoke arranged so as to face each other with the coil sandwiched between them. The actuator 155 is held by ball bearings (not shown) provided at the top and bottom, two places, of the spindle 157 in such a manner that it can pivotally slide freely with the voice coil motor 156.

Furthermore, the hard disk unit 150 includes a signal processing section 158 formed on a flexible substrate. The read amplifier, high-pass filter 3, reproduced-signal processing section 4, hard disk controller 5, and CPU 6 are mounted chiefly on the signal processing section 158. The read amplifier 2 may be mounted in the vicinity of the reproducing head 1 of the suspension 154.

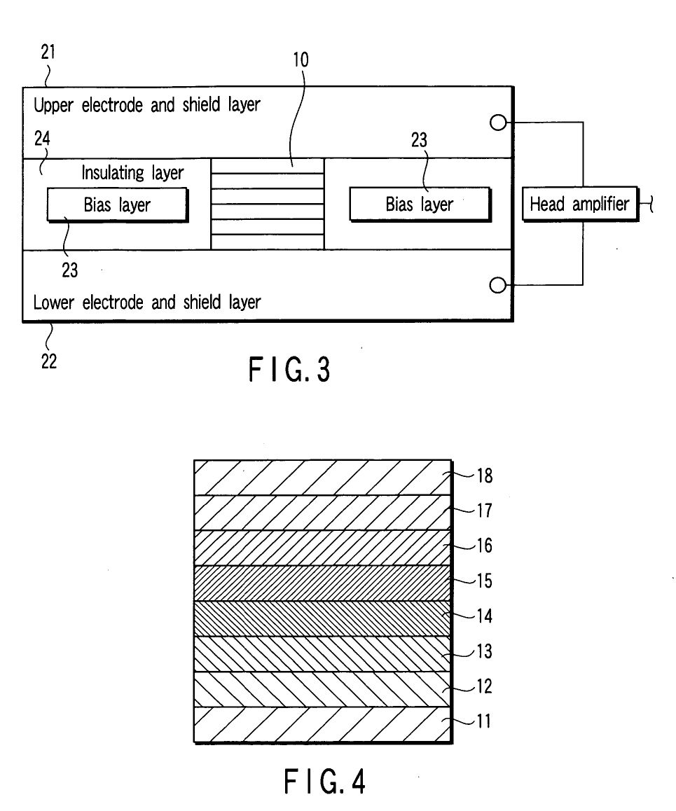

FIG. 3 is an exemplary sectional view showing a schematic configuration of the reproducing head of FIG. 1. The reproducing head 1 includes a magnetoresistive effect film 10 composed of a plurality of magnetic films stacked one on top of another. On each side of the magnetoresistive effect film 10, a bias layer 23 for applying a bias magnetic field to the magnetoresistive effect film 10 is formed in such a manner that it is wrapped in an insulating layer 24. An upper electrode and magnetic shield layer 21 and a lower electrode and magnetic shield layer 22 are formed on the top and bottom of the magnetoresistive effect film 10 and insulating layer 24, respectively. A read bias voltage is applied to these electrodes 21, 22, causing sense current to flow in the direction perpendicular to the film surface of the magnetoresistive effect film 10. A change in the sense current is input via a head amplifier to the read amplifier (FIG. 1). The magnetoresistive effect film 10 of FIG. 3 is of the current perpendicular to plane type. Even if it is of a small element size, for example, 90 nm×90 nm, a sufficient reproduced output can be obtained in the magnetic disk apparatus.

FIG. 4 is an exemplary sectional view showing a film configuration of the magnetoresistive effect film 10 of FIG. 3. In FIG. 4, on a substrate (not shown), a lower electrode 11, a foundation layer 12, an antiferromagnetic layer 13, a magnetization fixing layer 14, a nonmagnetic intermediate layer 15, a magnetization free layer 16, a protective layer 17, and an upper electrode 18 are stacked one on top of another in that order.

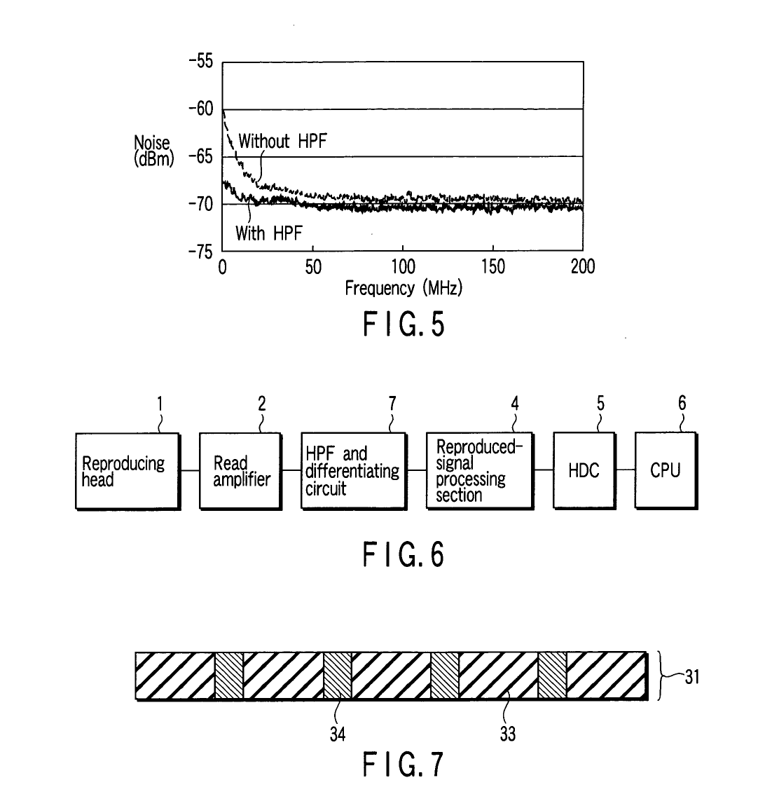

FIG. 5 shows an exemplary graph obtained by measuring the spectrum of head noise at the reproducing head 1 with and without the high-pass filter 3. This graph shows the result of measurements under the following condition: the read bias voltage=100 mV. As shown in FIG. 5, in the state where the high-pass filter 3 is provided, the noise level in the low-frequency region apparently decreases. Therefore, the S/N ratio of the reproduced signal is improved, which enables the occurrence of errors to be suppressed. Consequently, it is possible to make the recording density much higher.

It is characteristic of the current perpendicular to plane magnetoresistive effect film that the more its size is reduced, the more conspicuous noise caused by the spin transfer effect becomes. Since the noise appears as 1/f type noise, noise in the low-frequency region becomes larger. In the embodiment, to overcome this problem, the high-pass filter 3 is provided, thereby suppressing low-frequency noise, which lowers the overall noise power. This not only suppresses the distortion of the waveform of the reproduced signal but also improves the S/N ratio, which makes it possible to reduce reading errors.

Particularly under the conditions of FIG. 5, it is desirable that the cut-off frequency of the high-pass filter 3 should be set at 20 MHz. Specifically, the cut-off frequency of the high-pass filter 3 is set to 0.01 MHz or higher and 20 MHz or lower, preferably to 0.1 MHz or higher and 10 MHz or lower. When the cut-off frequency is 0.01 MHz or lower, it is difficult to suppress low frequencies effectively. Moreover, when the cut-off frequency is 20 MHz or higher, even the reproduced signal is suppressed.

As described above, in the embodiment, use of the high-pass filter 3 suppresses low-frequency noise in the reproduced signal, thereby eliminating an adverse effect caused by the spin transfer effect inherent to the current perpendicular to plane reproducing head. This improves the S/N ratio. In addition to this, use of the current perpendicular to plane magnetoresistive effect film 10 enables a sufficient reproduced output to be produced. Furthermore, since the element size can be reduced, the recording density can be made much higher.

### Second Embodiment

FIG. 6 is an exemplary functional block diagram of a second embodiment of a magnetic disk apparatus according to the present invention. The magnetic disk apparatus of FIG. 6 is such that the characteristic of the high-pass filter 3 of FIG. 1 is set suitably so as to function as a differentiating circuit. That is, in FIG. 6, a high-pass filter and differentiating circuit 7 is inserted between the read amplifier 2 that amplifies the reproduced signal from the reproducing head 1 and the reproduced-signal processing section 4. The high-pass filter and differentiating circuit 7 is obtained by setting the cut-off frequency of the high-pass filter 3 (FIG. 1) to a value that enables a reduction in noise caused by the spin transfer effect and the generation of differential waveforms to be compatible with each other.

The configuration of FIG. 6 can be used suitably in a perpendicular recording magnetic disk apparatus. As is well known, the waveform of the reproduced signal in the perpendicular recording method is rectangular. The waveform of the reproduced signal in the in-plane recording method is shaped like a pulse. Therefore, applying the configuration of FIG. 6 to the perpendicular recording magnetic disk apparatus makes it possible to differentiate a rectangular waveform to obtain a pulse waveform, which enables the same signal processing system as that of the in-plane recording method to be shared. Accordingly, it is possible to reduce costs by sharing parts and gain large merits in manufacturing products.

### Third Embodiment

FIG. 7 schematically shows an exemplary magnetoresistive effect film 10 in a third embodiment of a magnetic disk apparatus according to the present invention. In the third embodiment, the configuration of the nonmagnetic intermediate layer 17 in the magnetoresistive effect film 10 of FIG. 4 is changed. Specifically, instead of the uniform composition, the nonmagnetic intermediate layer (indicated by numeral 31) is so configured that a conductive material 34 lies scattered in an insulating material 33 as shown in FIG. 7. The insulating material 33 insulates adjacent layers (the magnetization fixing layer 14 and magnetization free layer 16 of FIG. 4) from one another electrically. The conductive material 34, which is formed dispersively in the insulating material 33, connects the magnetization fixing layer 14 and magnetization free layer 16 electrically. This causes sense current to pass through the conductive material in a confined manner. This phenomenon is known as the current confining effect. It is known that the effect makes the resistance of the nonmagnetic intermediate layer 3 larger. A layer having the configuration of FIG. 7 is referred to as a current control layer.

Since the magnetoresistive effect element having the current control layer of FIG. 7 has a high resistance changing rate, a higher recording-density magnetic disk apparatus can be realized. Meanwhile, since its size is small, noise caused by the spin transfer effect is conspicuous, with the result that the S/N ratio according to an increase in the output cannot be expected. To overcome this drawback, noise in the low-frequency region is removed by the high-pass filter, which makes it possible not only to suppress the distortion of the waveform of the reproduced signal and improve the S/N ratio but also reduce reading errors.

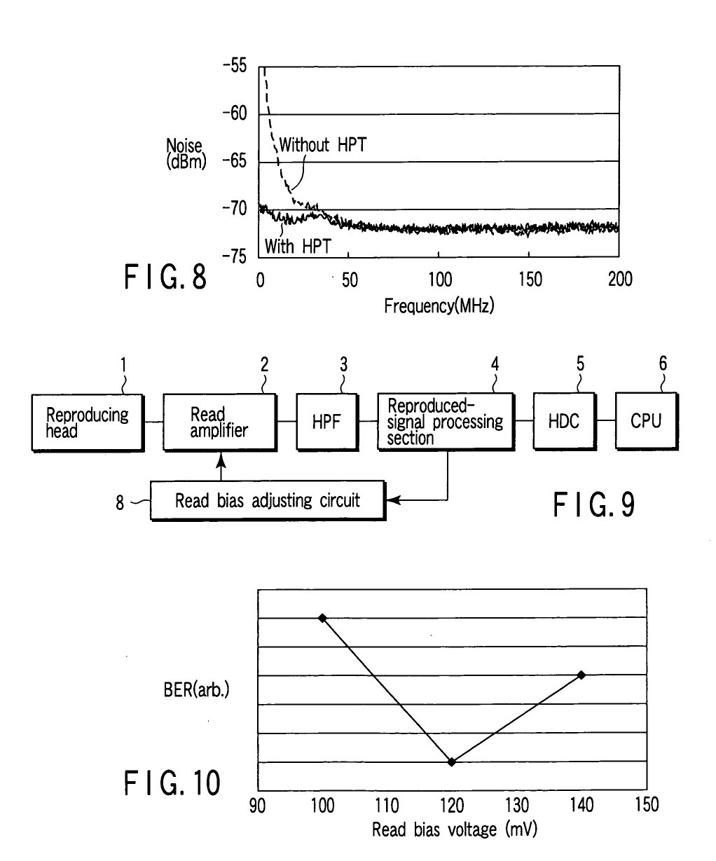

FIG. 8 shows a graph obtained by measuring the spectrum of head noise at the reproducing head 1 having a magnetoresistive effect film 10 including a current control layer in the case of the presence and absence of a high-pass filter and differentiating circuit 7. The graph shows the result of measurements under the following condition: the read bias voltage=100 mV. As shown in FIG. 8, in the state where the high-pass filter and differentiating circuit 7 is provided, the noise level in the low-frequency region apparently decreases. Therefore, the S/N ratio of the reproduced signal is improved, which enables the occurrence of errors to be suppressed. Consequently, it is possible to make the recording density much higher.

### Fourth Embodiment

FIG. 9 is an exemplary functional block diagram of a fourth embodiment of a magnetic disk apparatus according to the present invention. The magnetic disk apparatus of FIG. 9 is such that a read bias adjusting circuit 8 is added to the configuration of FIG. 1. The read bias adjusting circuit 8 performs feedback control of the read bias voltage of the reproducing head 1 on the basis of the incidence of errors in reading the reproduced signal or the S/N ratio.

FIG. 10 is an exemplary diagram to help explain the operation of the read bias adjusting circuit 8. This graph shows the result of measuring the relationship between the read bias voltage and the bit error rate (BER) in the current perpendicular to plane reproducing head of FIG. 3. The magnetoresistive effect film 10 was 70 nm wide and 70 nm long.

Under the above conditions, the read bias adjusting circuit 8 was caused to function by feedback from the reproduced-signal processing section 4, with the result that the read bias to minimize BER was 120 mV. That is, when BER was measured with the read bias being changed independently as shown in FIG. 10, BER became the smallest at a read bias voltage of 120 mV.

Although the reproduced output of the reproducing head 1 increases as the read bias voltage is raised, noise caused by the spin transfer effect increases accordingly. Moreover, the dependence of the noise on the read bias changes with the resistance of the reproducing head 1 or the intensity of the bias magnetic field from the bias layer 23. That is, the read bias value to minimize BER varies one reproducing head 1 to another. Actually, the resistance of the reproducing head or the intensity of the bias magnetic field from the bias layer varies according to variations in the manufacture, so that it is difficult to set the optimum value in advance.

In contrast, the fourth embodiment makes it possible to set the optimum read bias values separately to individual current perpendicular to plane magnetic heads differing in conditions from one another. Accordingly, it is possible to stably manufacture a magnetic disk apparatus with the minimized incidence of reading errors.

This invention is not limited to the above embodiments. For instance, in the forth embodiment, the sense current may be changed directly instead of the read bias voltage.

While certain embodiments of the inventions have been described, these embodiments have been presented by way of example only, and are not intended to limit the scope of the inventions. Indeed, the novel apparatuses and systems described herein may be embodied in a variety of other forms; furthermore, various omissions, substitutions and changes in the form of the apparatuses described herein may be made without departing from the spirit of the inventions. The accompanying claims and their equivalents are intended to cover such forms or modifications as would fall within the scope and spirit of the inventions.

What is claimed is:

1. A magnetic disk apparatus with a magnetic disk medium capable of recording data magnetically, comprising:
a current perpendicular to plane magnetic reproducing head which includes a magnetoresistive effect element composed of a plurality of magnetic films stacked one on top of another and causes sense current to flow in the direction perpendicular to the stacked faces of said plurality of magnetic films;
a high-pass filter which suppresses the low-frequency component of a reproduced signal output from the magnetic reproducing head; and
a reproduced-signal processing section which reproduces the data from the reproduced signal which has the low-frequency component suppressed.

2. The magnetic disk apparatus according to claim 1, wherein the cut-off frequency of the high-pass filter is 0.01 MHz or higher and 20 MHz or lower.

3. The magnetic disk apparatus according to claim 1, wherein the magnetoresistive effect element includes a nonmagnetic intermediate layer, and
the nonmagnetic intermediate layer includes an insulating material which insulates adjacent layers from each other electrically, and
a conductive material which is formed dispersively the insulating material, connects the adjacent layers to each other electrically, and causes the sense current to pass through in a confined manner.

4. The magnetic disk apparatus according to claim 1, wherein the magnetic disk medium uses a perpendicular recording method.

5. The magnetic disk apparatus according to claim 4, wherein the cut-off frequency of the high-pass filter is set so as to input a differential waveform of the reproduced signal to the reproduced-signal processing section.

6. The magnetic disk apparatus according to claim 1, wherein the magnetic disk medium uses an in-plane recording method.

7. The magnetic disk apparatus according to claim 1, further comprising: a bias control section which performs feedback control of the read bias voltage of the magnetic reproducing head on the basis of the incidence of errors in reading the reproduced signal.
